(19) United States
(12) Patent Application Publication
(10) Pub. No.: US 2006/0029728 A1
(43) Pub. Date: Feb. 9, 2006

(54) Method of repair for plastic automotive body panels

(76) Inventor: Roger Stull, Des Moines, WA (US)

Correspondence Address: David L. Garrison;Garrison & Associates PS, Suite 3300, 2001 Sixth Avenue, Seattle, WA, 98121-2522, US

(21) Appl. No.: 11/197,051

(22) Filed: Aug. 3, 2005

Related U.S. Application Data
(60) Provisional application No. 60/598,675, filed on Aug. 3, 2004.

(51) Int. Cl. B05D 3/00; B32B 43/00

(52) U.S. Cl. 427/140

(57) ABSTRACT

A method for repairing vinyl/plastic bumpers and panels is disclosed. The method involves first cleaning the surface of a bumper around a damaged area. The damaged area, is then prepared for repair by melting the high points and sanding the area with fine gritted abrasives. Putty is used to fill any depressions, and the area is sanded again. The area is then cleaned and primer is used to seal the putty and to fill in any minor imperfections. After the primer dries, a plurality of medium wet coats of tinted vinyl resin are used to paint the bumper such that it has the same texture and color as the original finish. The disclosed method can be completed in a shop or done as an on site repair by a technician with a mobile unit.

### TECHNICAL FIELD

This invention relates generally to a method for repairing plastic automotive body panels and more particularly to a method for repairing, resurfacing and painting vinyl bumpers of cars and trucks.

### BACKGROUND OF THE INVENTION

It is a common practice for auto manufacturers to make modern vehicles with front and rear plastic bumpers. One type of these plastic bumpers is commonly referred to as vinyl bumpers, which can be identified by the appearance and texture of the bumper.

Most plastic bumpers are generally finished such that the bumper is the same color as the vehicle to which it is attached and the bumper has a smooth finish that matches the finished texture of the vehicle. Vinyl bumpers generally are a different color than the vehicle to which they are attached and they have a raised texture that is not as smooth as the finish of the vehicle to which they are attached. Because vinyl bumpers are less expensive to manufacture and install than previous embodiments of plastic bumpers, automotive manufacturers are beginning to use more of these bumpers on vehicles where the bumpers are not aesthetically offensive.

These bumpers are designed to absorb shock during collisions and they can generally withstand an impact of 5-10 miles per hour with relatively little damage to the interior of the bumper or the occupants of the vehicle. However, these impacts and other more traumatic impacts can cause the bumper to become scratched, torn, punctured, dented, or otherwise damaged. While methods and techniques exist to repair other types of bumpers including other types of plastic bumpers, there has been no reliable method for repairing vinyl bumpers such that any repairs were not detectable to all but the most trained person.

Because there was no reliable repair method, damaged vinyl bumpers were usually removed from the vehicle and replaced with another vinyl bumper. Such practice resulted in significant expense to the vehicle owner and an undue burden on society as a whole in that the damaged bumper had to be disposed of, usually in a landfill. Therefore, a need exists for a reliable method for repairing vinyl bumpers. Such a method that would provide repairs that are of relatively good quality and less expensive than replacing the bumper would be a significant improvement over what is currently available.

### SUMMARY OF THE INVENTION

Therefore, it is an object of the current invention to disclose a method for repairing vinyl bumpers.

Another object of the invention is to provide such a method that is less expensive than replacing a bumper.

A further object of the invention is to provide such a method that is of high quality that matches the original texture and color of the bumper.

The current invention satisfies those objects and others that will become apparent in the disclosure below, by providing a method for repairing vinyl bumpers. As noted above, the term vinyl bumper is used to define a plastic bumper that does not have the same texture or color as the finish on a motor vehicle to which it is attached. Modern vehicles often have plastic bumpers and while some bumpers have the same texture and color as the finish of the vehicle, it is becoming more common to have a textured bumper that is generally a different color than the remainder of the vehicle. The texture is generally due to the fact that the bumper has not been sanded and buffed to a smooth finish like the other exterior parts of the vehicle. These bumpers are usually made from vinyl thus the term vinyl bumper. In most cases the bumpers are some shade of black although they can be other colors, including the color of the vehicle.

The method for repairing the bumpers involves first cleaning the surface of a bumper around a damaged area. The damaged area is then prepared for repair by melting the high points and sanding the area with fine gritted abrasives. Putty is used to fill any depressions, and the area is sanded again. The area is then cleaned and primer is used to seal the putty and to fill in any minor imperfections. After the primer dries, a plurality of medium wet coats of tinted vinyl resin are used to paint the bumper such that it has the same texture and color as the original finish. The disclosed method can be completed in a shop or done as an on site repair by a technician with a mobile unit.

### BRIEF DESCRIPTION OF THE DRAWINGS

The objects and features of the present invention, which are believed to be novel, are set forth in the appended claims. The present invention, both as to its organization and manner of operation, together with further objects and advantages, may best be understood by reference to the following descriptions, taken in conjunction with the accompanying drawings, wherein:

FIG. 1 is a flow diagram showing the steps of the method disclosed herein

FIG. 2 is a schematic cross section of a vinyl bumper after the bumper has been repaired and sanded.

### DETAILED DESCRIPTION OF THE INVENTION

Turning now to the drawings, the forms and accessories will be described in preferred embodiments by reference to the numerals of the drawing figures wherein like numbers indicate like parts.

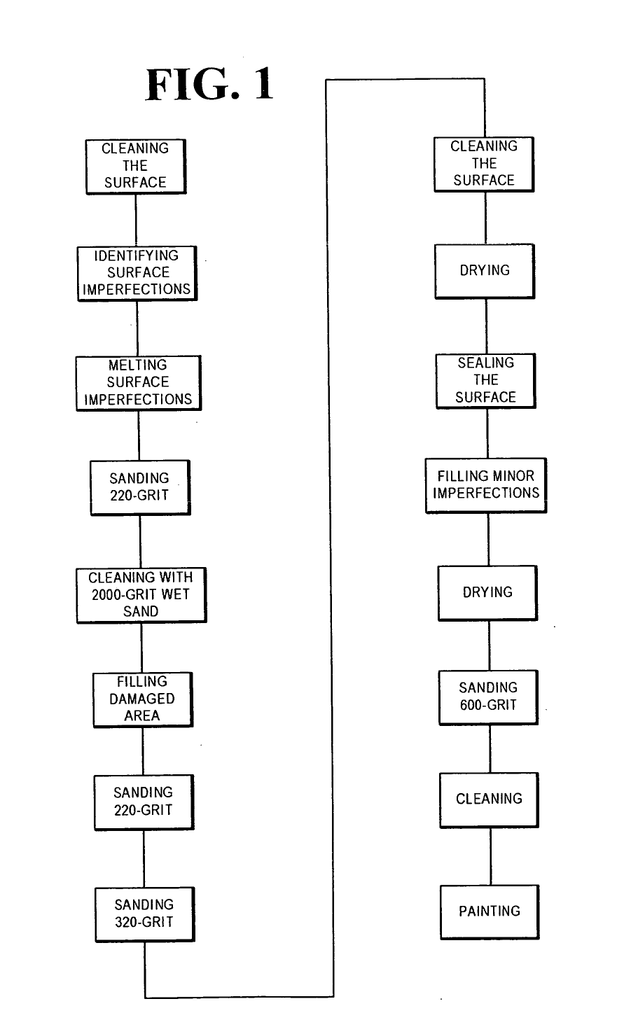

The steps are illustrated in the flow diagram of a preferred embodiment that is shown in FIG. 1.

According to the method disclosed for the preferred embodiment shown in FIG. 1, after an area has been identified as needing to be repaired, it is thoroughly cleaned and degreased. After the damaged area has been cleaned, any gross imperfections that extend above the surface of the bumper are identified. The gross imperfections are then melted such that the high points are melted and the melted material is spread along the surface of the bumper in the immediate area of the high point. The melting and spreading can be accomplished using any tool or combination of tools capable of providing sufficient heat to melt the high points and spread the melted material. In one preferred embodiment, as depicted in the figures, a soldering tool is used.

After the imperfections have been reduced, the damaged area is sanded using a 220-grit or finer abrasive until the area to be repaired is slightly lower than the original surface of the bumper.

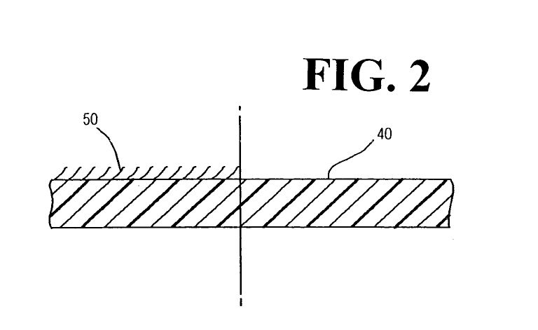

It is important to note that abrasives having a grit that is too course must not be used for repairing bumpers according to the method herein. Should such courser grit abrasives be used, the resultant sanded area has a plurality of hair like fibers extending therefrom. An example of such fibers 50, on a repair surface 40 that has been sanded with a course grit, are illustrated in FIG. 2. The hair like fibers make it extremely difficult, if not impossible, to restore a bumper to a texture matching the original texture.

Once the repair surface has undergone the initial sanding, it is cleaned using a 2000-grit wet sanding abrasive or the equivalent thereof. After the area has been cleaned, a layer of putty is then spread onto the repair area such that the damaged area is now level with or slightly higher that the original surface of the bumper. In one preferred embodiment, a two-part urethane based polyester spot putty is used, but other types of putty are also contemplated. It should be noted that lacquer based putties or other similar putties that never fully cure, should not be used.

The putty is allowed to cure, and then it is fine sanded using a 220-grit or finer abrasive to ensure that the repair surface is at the same level as the original level of the bumper. After the repair area has been fine sanded, it is then finish sanded using a 320-grit or finer abrasive the area is then cleaned and dried. In one preferred embodiment compressed air is used to dry the repair surface after cleaning.

After the repair surface is dry, first thin coat of a non-lacquer-based primer is then applied to the bumper using a paint spray gun. This first coat effectively seals the repair surface. A second thicker coat of primer is then applied to the repair surface, thereby filling in any minor imperfections. The primed area is allowed to dry and then sanded with a 600-grit or smaller abrasive.

The repair surface is then cleaned with water and allowed to dry. After cleaning, the repair area is then painted with a urethane based tinted vinyl resin by applying a first medium wet coat of paint. A second medium wet coat of paint is over sprayed to blend the repair area with the surrounding surface of the bumper. Subsequent medium wet coats of paint are then applied to match the color and texture of the repair surface to the original color and texture of the bumper. The paint is tinted to match the color of the bumper being repaired, and in one embodiment ten grams of tint are used for every twenty-four grams of vinyl resin.

The paint is applied using a high pressure low volume spay gun. One embodiment of the method disclosed herein can be accomplished using a gun having a one-millimeter tip but tips larger than one-millimeter can be used for other embodiments. The spray gun is used with a system that allows the air pressure to be adjusted and in one embodiment the paint is applied using an air pressure no greater than 30 pounds per square inch for the spray gun. The spray gun is held further away from the work surface than the distance that it would generally be held when applying other paints, and in one embodiment the distance between the paint gun and the work surface is eight inches.

The texture of the repair surface can be adjusted by moving the spray gun further away from the work surface, lowering the air pressure, or a combination of both thereby allowing a repair person to match the texture and sheen of a bumper being repaired. Moving the spray gun away from the work surface and lowering the air pressure causes the texture of the repair surface to be more course that the texture of a surface repaired with the gun set at thirty pounds per square inch or held eight inches from the work surface. Another method for creating a courser texture is to scuff the repair surface with a scuff pad while the paint is still slightly wet.

In one preferred embodiment of the method disclosed above, the sanding is done using a dual-oscillating sander. Repairing a bumper according to the method disclosed above can take place in a repair shop or it can be done by technician at a location that is away from the repair shop.

### INDUSTRIAL APPLICABILITY

The invention has applicability in the field of automotive and plastic repair. In particular the current invention describes a method for repairing a vinyl/plastic bumper or panel. The disclosed method is less expensive than replacing a bumper, and it can be completed in a repair shop or at a remote location. Additionally, the disclosed method produces a repair that is of high quality and matches the original texture and color of the bumper. In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

What is claimed is:

1. The method for repairing a damaged area on a surface of a vinyl/plastic panel comprising the steps of:
cleaning the surface;
identifying gross surface imperfections that extend outward from the outer surface;
melting the gross surface imperfections such that high points are reduced and low points are filled;
sanding the surface of the damaged area such that the damaged area is lower that the original surface;
cleaning the surface of the sanded damaged area;
filling the damaged area;
sanding the filled damaged area;
cleaning the surface of the damaged area;
allowing the damaged area to dry;
sealing the surface of the damaged area;
filling in minor imperfections in the surface of the damaged area;
sanding the sealed damaged area;
cleaning the damaged area; and
painting the damaged area such that the color and texture of the painted damaged area match the original color and texture of the plastic/vinyl panel.

2. The method of claim 1 wherein the low points are filled with molten plastic material from the panel.

3. The method of claim 1 wherein when the surface of the damaged area is sanded such that it is lower that the original surface, the abrasive used for the sanding is 220-grit or finer.

4. The method of claim 3 wherein a dual-oscillating sander is used for sanding the surface of the damaged area.

5. The method of claim 1 wherein the surface of the damaged area is cleaned using 2000-grit wet sanding abrasive.

6. The method of claim 5 wherein the surface of the damaged area is cleaned using the equivalent of a 2000-grit wet sanding abrasive.

7. The method of claim 1 wherein the damaged area is filled using a urethane based polyester spot putty and the putty is allowed to cure before the filled damaged area is sanded.

8. The method of claim 1 wherein the filled damaged area is sanded first with a 220-grit abrasive and then finish sanded with a 320 grit abrasive.

9. The method of claim 8 where a dual-oscillating sander is used for sanding the filled damaged area.

10. The method of claim 1 wherein the surface of the damaged area is sealed by applying a first coat of non-lacquer based primer and the minor surface imperfections are filled by applying a second coat of the primer.

11. The method of claim 1 wherein the sealed damaged area is sanded with a 600-grit abrasive.

12. The method of claim 11 where a dual-oscillating sander is used for sanding the sealed damaged area.

13. The method of claim 1 wherein the damaged area is painted with a urethane based vinyl resin that is tinted to match the original color of the vinyl/plastic panel.

14. The method of claim 13 wherein the amount of tint in the vinyl resin does not exceed ten grams of tint for every twenty-four grams of resin.

15. The method of claim 13 wherein the damaged area is painted with a first medium-wet coat of paint, then a second medium wet coat that is over-sprayed to blend the texture of the paint with the original texture of the vinyl/plastic panel; and
sufficient subsequent coats of paint such that the color and texture of the painted damaged area match the original color and texture of the plastic/vinyl panel.

16. The method of claim 13 wherein the vinyl resin is applied using a high pressure low volume spray gun having a one millimeter tip, wherein the spray gun is pneumatic and the air pressure for operating the spay gun can be adjusted.

17. The method of claim 16 wherein the vinyl resin is applied using an air pressure less than thirty pounds per square inch for the spray gun.

18. The method of claim 16 wherein the distance between the spray gun and the vinyl/plastic panel during application of the resin is at least eight inches.

19. The method of claim 16 wherein the distance between the spray gun and the vinyl/plastic panel during application of the resin is greater than eight inches.

20. The method for repairing a damaged area on a surface of a vinyl/plastic bumper of a motor vehicle comprising the steps of:
cleaning the surface;
identifying gross surface imperfections that extend outward from the outer surface;
melting the gross surface imperfections such that high points are reduced and low points are filled with molten material from the bumper;
sanding the surface of the damaged area using an abrasive that is no coarser than 220-grit such that the damaged area is lower that the original surface;
cleaning the surface of the sanded damaged area by wet sanding it with a 2000-grit abrasive;
filling the damaged area using a non-lacquer based putty;
allowing the putty to cure;
sanding the filled damaged area are using an abrasive that is no coarser than 220-grit such that the damaged area is level with the remainder of the bumper;
sanding the filled damaged area are using an abrasive that is no coarser than 320-grit such that the damaged area is relatively smooth;
cleaning the surface of the damaged area;
allowing the damaged area to dry;
sealing the surface of the damaged area with a first thin coat of non-lacquer based primer that is applied with a pneumatic spray gun;
filling in minor imperfections in the surface of the damaged area with a second coat of primer that is thicker than the first thin coat of primer and is also applied with a pneumatic spray gun;
allowing the primed area to dry
sanding the sealed damaged area using an abrasive that is no coarser than 600-grit such that the damaged area is relatively smooth;
cleaning the damaged area;
painting the damaged area by applying a first medium-wet coat of a urethane based vinyl resin that is tinted to match the color of the vinyl/plastic bumper
using a high pressure low volume pneumatic spray gun having a spray nozzle no smaller than one millimeter and wherein the air pressure for operating the spray gun can be adjusted;
applying a second medium-wet coat of the urethane based vinyl resin that is over sprayed such that the texture of the paint is blended with the original texture of the vinyl/plastic bumper; and
applying sufficient subsequent coats of the urethane based vinyl resin such that the color and texture of the painted damaged area match the original color and texture of the plastic/vinyl panel.
